(19) United States
(12) Patent Application Publication
(10) Pub. No.: US 2026/0086828 A1
(43) Pub. Date: Mar. 26, 2026

(54) IDENTIFCATION OF USER INTERFACE ELEMENTS IN A PAGE OF AN APPLICATION USING HEURISTIC RULES AND A LARGE LANGUAGE MODEL

(71) Applicant: INTERNATIONAL BUSINESS MACHINES CORPORATION, ARMONK, NY (US)

(72) Inventors: Sami Marreed, Kafer Kanna (IL); AVI YAELI, Haifa (IL); Offer Akrabi, Lehavot Habashan (IL); Segev Shlomov, Haifa (IL); Nir Mashkif, Geva Carmel (IL)

(21) Appl. No.: 18/898,580

(22) Filed: Sep. 26, 2024

(51) Int. Cl. G06F 9/451

(52) U.S. Cl. CPC G06F 9/451

(57) ABSTRACT

A computer-implemented method includes applying a set of heuristic rules to a page of an application to identify a plurality of user interface (UI) elements in the page; displaying the page, including visually highlighting each UI element of the plurality that is identified by the set of rules; receiving user feedback that identifies each UI element of the plurality that is not visually highlighted; and using a first pipeline of a Large Language Model to create a new rule identifying each UI element that is not visually highlighted

### BACKGROUND

### Technical Field

The present disclosure generally relates to user interface (UI) automation, and more particularly, to tools for providing information about elements of a UI.

### Description of the Related Art

UI Automation refers to a framework that enables applications to provide and ingest information about elements of a UI. UI Automation clients can register for specific event notifications and they can request that specific UI Automation properties and control pattern information be passed into their event handlers. UI Automation may also provide tools for automating tasks across multiple applications.

UI automation tools may include automation agents for selecting the correct UI element to interact with. Selecting elements with high accuracy ensures reliable results and reduces the risk of errors. This, in turn, enhances computational efficiency.

Challenges in maintaining high accuracy have arisen from limitations in interpreting complex data (e.g., complex UI elements), adapting to changes in dynamic environments, and handling unforeseen situations. High accuracy is achieved by experts who navigate intricate coding and design requirements.

### SUMMARY

According to an embodiment of the present disclosure, a computer-implemented method includes applying a set of heuristic rules to a page of an application to identify a plurality of UI elements in the page; displaying the page, including visually highlighting each UI element of the plurality that is identified by the set of rules; receiving user feedback that identifies each UI element of the plurality that is not visually highlighted; and using a first pipeline of an LLM to create a new rule identifying each UI element that is not visually highlighted.

In some embodiments, the set of heuristic rules includes a first subset for identifying individual UI elements; a second subset for detecting UI element groups; and a third subset for detecting UI element context.

In some embodiments, the method further includes iteratively testing and adjusting each new rule until its corresponding UI element is accurately identified.

In some embodiments, using the first pipeline includes creating a prompt for a given new rule, and sending the prompt to the LLM. The prompt is iteratively tested and adjusted with the user feedback until the given new rule accurately identifies its corresponding UI element.

In some embodiments, the prompt for the given new rule includes instructions for creating a selector, and attributes of the corresponding UI element.

In some embodiments, the method further includes using a second pipeline of the LLM to suggest names for a given UI element that is not visually highlighted.

In some embodiments, using the second pipeline includes creating a prompt for a given UI element, and sending the prompt to the LLM. The prompt includes instructions for selecting a plurality of names, and a one-shot input. The one-shot input has the following form:
[style/state modifier] [name] [type] [anchoring reference]
   where the style, state, name and type are attributes of the given UI element, and the anchoring reference describes context of the given UI element.

In some embodiments, the method further includes identifying states of stateful UI elements; displaying the identified states; and obtaining additional user feedback to update any displayed states.

According to an embodiment of the present disclosure, a computer system includes a memory having computer readable instructions, and one or more processors for executing the computer readable instructions to configure the computer system to run an application to display a page including a UI; apply a set of heuristic rules to the page to identify a plurality of UI elements; display the page including the plurality of UI elements; visually highlight each UI element of the plurality that is identified by the set of rules; receive user feedback that identifies each UI element of the plurality that is not visually highlighted; and use a first pipeline of an LLM to create a new rule identifying each UI element that is not visually highlighted.

In some embodiments, the computer readable instructions, when executed, further configure the one or more processors to iteratively test and adjust each new rule until its corresponding UI element is accurately identified.

In some embodiments, a prompt for a given new rule is created and sent to the LLM. The prompt is iteratively adjusted with the user feedback until the given new rule accurately identifies its corresponding UI element.

In some embodiments, the prompt for the given new rule includes instructions for creating a selector, and attributes of the corresponding UI element.

In some embodiments, the computer readable instructions, when executed, further configure the one or more processors to use a second pipeline of the LLM to suggest names for a given UI element that is not visually highlighted.

According to an embodiment of the present disclosure, a computer program product includes one or more computer-readable memory devices encoded with data including computer-readable instructions that, when executed, causes a processor set to carry out a method of identifying UI elements in a page of an application. The method includes applying a set of heuristic rules to the page to identify the UI elements; displaying the page; visually highlighting each of the UI elements that is identified by the set of rules; receiving user feedback that identifies each of the UI elements that is not visually highlighted; and using a first pipeline of an LLM to create a new rule identifying each UI element that is not visually highlighted.

In some embodiments, the computer readable instructions, when executed, further configure the processor set to iteratively test and adjust each new rule until its corresponding UI element is accurately identified.

In some embodiments, a prompt for a given new rule is created and sent to the LLM. The prompt is iteratively adjusted with the user feedback until the given new rule accurately identifies its corresponding UI element.

In some embodiments, the prompt for the given new rule includes instructions for creating a selector, and attributes of the corresponding UI element.

In some embodiments, the computer readable instructions, when executed, further configure the processor set to use a second pipeline of the LLM to suggest names for each UI element that is not visually highlighted.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a computing environment, consistent with an illustrative embodiment.

FIG. 2 is a computer-implemented method, consistent with an illustrative embodiment.

FIG. 3 is a computer-implemented method, consistent with an illustrative embodiment.

FIG. 4 is a file of heuristic rules, consistent with an illustrative embodiment.

FIG. 5 is a screen of web page with certain UI elements visually highlighted, consistent with an illustrative embodiment.

FIG. 6 is a prompt for generating suggested names of a UI element, consistent with an illustrative embodiment.

FIG. 7 is a prompt for generating a new heuristic rule, consistent with an illustrative embodiment.

### DETAILED DESCRIPTION

### Overview and Support

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to identification of UI elements in a page of an application. By virtue of the concepts discussed herein, large language models (LLMs) are used, but not to directly identify UI elements. LLMs have probabilistic outcomes, and their resulting uncertainty can complicate their use in critical automated processes. Instead, heuristic rules are used to identify the UI elements. If the heuristic rules fail to identify a UI element, an LLM is used to add a new rule or refine an existing rule in order to properly identify that UI element.

According to an embodiment of the present disclosure, a computer-implemented method includes applying a set of heuristic rules to a page of an application to identify a plurality of UI elements in the page; displaying the page, including visually highlighting each UI element of the plurality that is identified by the set of rules; receiving user feedback that identifies each UI element of the plurality that is not visually highlighted; and using a first pipeline of an LLM to create a new rule identifying each UI element that is not visually highlighted.

Accuracy and predictability of identifying UI elements in a page of an application are improved by the combination of the heuristic rules, the user feedback, and the LLM. Moreover, the accuracy and predictability can be improved by non-technical users who do not have the skill or training to navigate intricate coding and design requirements.

The method enables UI automation tools to select UI elements with high accuracy. Selecting elements with high accuracy ensures reliable results and reduces the risk of errors.

In some embodiments, which can be combined with the previous embodiment, the set of heuristic rules includes a first subset for identifying individual UI elements; a second subset for detecting UI element groups; and a third subset for detecting UI element context. The detection of groups and context can further improve the accuracy and predictability.

In some embodiments, which can be combined with one or more of the previous embodiments, the highlighting includes creating a bounding box around each UI element that is identified by the set of rules; and displaying text describing each UI element within a bounding box.

In some embodiments, which can be combined with one or more of the previous embodiments, the method further includes iteratively testing and adjusting each new rule until its corresponding UI element is accurately identified. The iterative testing and adjusting, in combination with the user feedback, reduces any uncertainty introduced by the LLM.

In some embodiments, which can be combined with one or more of the previous embodiments, using the first pipeline includes creating a prompt for a given new rule, and sending the prompt to the LLM. The prompt is iteratively tested and adjusted with the user feedback until the given new rule accurately identifies its corresponding UI element. The iterative testing and adjusting, in combination with the user feedback, reduces any uncertainty introduced by prompt engineering, as well as any uncertainty introduced by the LLM.

In some embodiments, which can be combined with one or more of the previous embodiments, the prompt for the given new rule includes instructions for creating a selector, and attributes of the corresponding UI element. The prompt can be generated by non-technical users who do not have the skill or training to navigate intricate coding and design requirements.

In some embodiments, which can be combined with one or more of the previous embodiments, the method further includes using a second pipeline of the LLM to suggest names for a given UI element that is not visually highlighted. This leads to more predictable naming.

In some embodiments, which can be combined with one or more of the previous embodiments, using the second pipeline includes creating a prompt for a given UI element, and sending the prompt to the LLM. The prompt includes instructions for selecting a plurality of names, and a one-shot input. The one-shot input has the following form:
[style/state modifier] [name] [type] [anchoring reference]
   where the style, state, name and type are attributes of the given UI element, and the anchoring reference describes context of the given UI element. The prompt can be generated by non-technical users who do not have the skill or training to navigate intricate coding and design requirements.

In some embodiments, which can be combined with one or more of the previous embodiments, the method further includes identifying states of stateful UI elements; displaying the identified states; and obtaining additional user feedback to update any displayed states. Accuracy is further increased.

The method further includes updating the set with each new rule created by the LLM. This enables the rules to be leveraged by other users and other applications.

According to an embodiment of the present disclosure, a computer system includes a memory having computer readable instructions, and one or more processors for executing the computer readable instructions to configure the computer system to run an application to display a page including a UI; apply a set of heuristic rules to the page to identify a plurality of UI elements; display the page including the plurality of UI elements; visually highlight each UI element of the plurality that is identified by the set of rules; receive user feedback that identifies each UI element of the plurality that is not visually highlighted; and use a first pipeline of an LLM to create a new rule identifying each UI element that is not visually highlighted.

Accuracy and predictability of identifying UI elements in a page of an application are improved by the combination of the heuristic rules, the user feedback, and the LLM. Moreover, the accuracy and predictability can be improved by non-technical users who do not have the skill or training to navigate intricate coding and design requirements.

The method enables UI automation tools to select UI elements with high accuracy. Selecting elements with high accuracy ensures reliable results and reduces the risk of errors.

In some embodiments, which can be combined with the previous embodiment, the computer readable instructions, when executed, further configure the one or more processors to iteratively test and adjust each new rule until its corresponding UI element is accurately identified.

In some embodiments, which can be combined with one or more of the previous embodiments, a prompt for a given new rule is created and sent to the LLM. The prompt is iteratively adjusted with the user feedback until the given new rule accurately identifies its corresponding UI element.

In some embodiments, which can be combined with one or more of the previous embodiments, the prompt for the given new rule includes instructions for creating a selector, and attributes of the corresponding UI element.

In some embodiments, which can be combined with one or more of the previous embodiments, the computer readable instructions, when executed, further configure the one or more processors to use a second pipeline of the LLM to suggest names for a given UI element that is not visually highlighted.

According to an embodiment of the present disclosure, a computer program product includes one or more computer-readable memory devices encoded with data including computer-readable instructions that, when executed, causes a processor set to carry out a method of identifying UI elements in a page of an application. The method includes applying a set of heuristic rules to the page to identify the UI elements; displaying the page; visually highlighting each of the UI elements that is identified by the set of rules; receiving user feedback that identifies each of the UI elements that is not visually highlighted; and using a first pipeline of a Large Language Learning model (LLM) to create a new rule identifying each UI element that is not visually highlighted.

Accuracy and predictability of identifying UI elements in a page of an application are improved by the combination of the heuristic rules, the user feedback, and the LLM. Moreover, the accuracy and predictability can be improved by non-technical users who do not have the skill or training to navigate intricate coding and design requirements.

The method enables UI automation tools to select UI elements with high accuracy. Selecting elements with high accuracy ensures reliable results and reduces the risk of errors.

In some embodiments, which can be combined with the previous embodiment, the computer readable instructions, when executed, further configure the processor set to iteratively test and adjust each new rule until its corresponding UI element is accurately identified.

In some embodiments, which can be combined with one or more of the previous embodiments, a prompt for a given new rule is created and sent to the LLM. The prompt is iteratively adjusted with the user feedback until the given new rule accurately identifies its corresponding UI element.

In some embodiments, which can be combined with one or more of the previous embodiments, the prompt for the given new rule includes instructions for creating a selector, and attributes of the corresponding UI element.

In some embodiments, which can be combined with one or more of the previous embodiments, the computer readable instructions, when executed, further configure the processor set to use a second pipeline of the LLM to suggest names for each UI element that is not visually highlighted.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

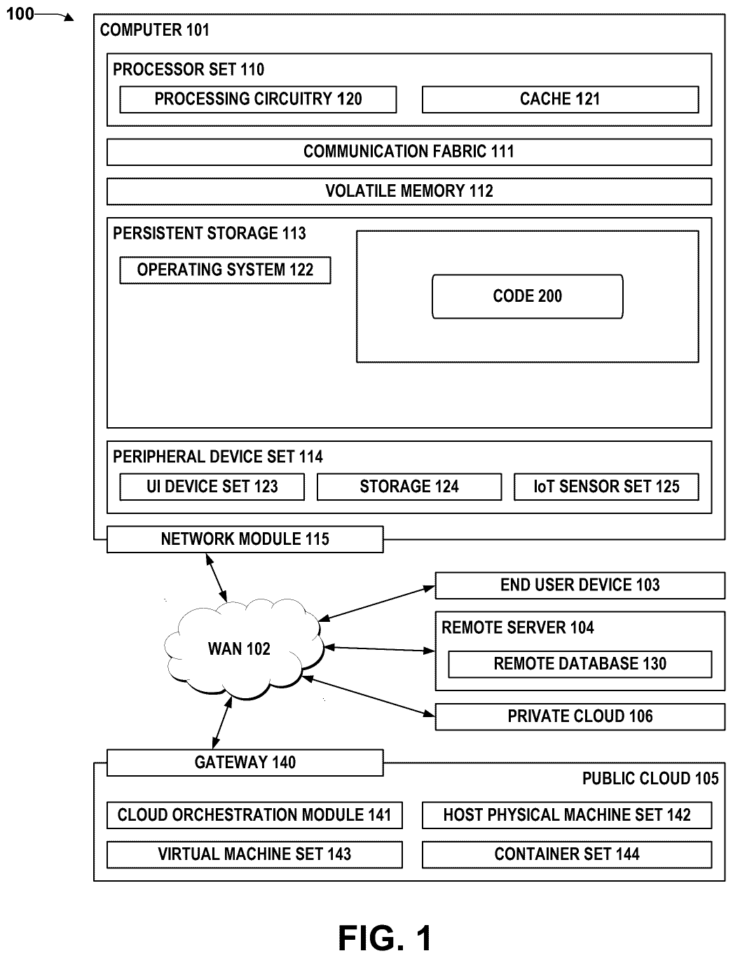

Reference is made to FIG. 1. Computing environment 100 contains an example of an environment for the execution of at least some of the computer code 200 involved in performing the inventive methods, such as identifying UI elements in a page of an application. In addition to the code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example Method of Identifying and Naming UI Elements

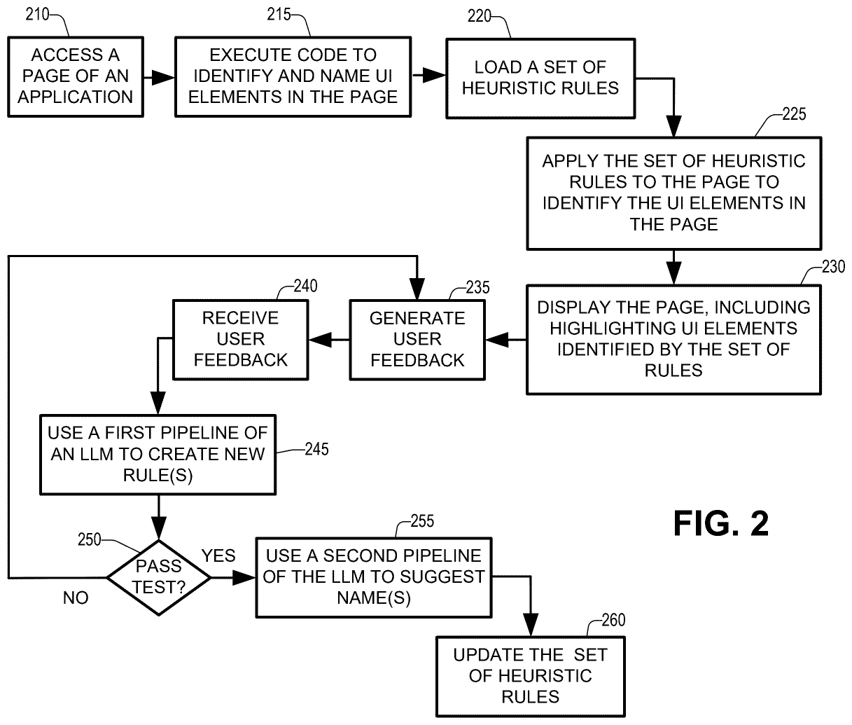

Reference is made to FIG. 2, which illustrates a computer-implemented method for identifying UI elements in a page of an application. A UI generally refers to the space in which a user and a computer system interact, in particular through the use of input devices and software. The UI may graphical, voice-controlled, gesture-based, etc.

A page of an application refers to a document that is accessed by an application. The document may be written in a language that represents a user interface. Hypertext Markup Language (HTML) is a standard markup language or documents designed to be displayed in a web browser. Extensible Markup Language (XML) is a markup language and file format for storing, transmitting, and reconstructing arbitrary data.

The page includes UI elements. Examples of standard UI elements for a graphical user interface (GUI) include buttons, charts, check boxes, dropdowns, feeds, forms, icons, input fields, loaders and modals. Other examples include custom UI elements.

At block 210, a page of an application is accessed. For example, an application such as a web browser running on the computer 101 may download an HTML file from a remote location (e.g., a web server running on the remote server 104) or from local storage (e.g., the persistent storage 113 or the private cloud 106). UI elements of the page are displayed by the application.

It might be desired to obtain information about the UI in the page that is being displayed. For example, the information might be used by UI automation tools such as automation agents to select the correct UI elements for UI automation.

At block 215, the computer 101 executes the code 200 of FIG. 1 to identify and name the UI elements in the page. The code 200 may be run from a web browser as a plugin or extension, or it may be run from another type of application via an application programming interface (API).

At block 220, the computer 101 loads a set of heuristic rules. The heuristic rules may include global rules and application-specific rules. The global rules are configured to identify UI elements across different applications. The set of rules may be stored in a database, such as remote database 130. The set of rules may include a first subset for identifying UI elements, a second sub set for detecting UI element groups, and a third subset for detecting modal UI elements.

At block 225, the computer 101 applies the set of heuristic rules to the page to identify the UI elements in the page. As used herein, applying the rules to a page includes applying the set of rules directly to the page and also applying the set of rules to a document object model (DOM) of the page. When a web page is loaded, the browser creates a DOM of the page, which is a hierarchical tree-like structure that organizes the elements of the page as objects. The set of rules may be applied to each object of the DOM. Examples of rules are provided below.

At block 230, the computer 101 displays the page, including the UI. The computer 101 visually highlights each UI element that is identified by the set of rules. For example, a bounding box of a certain color may be formed about identified UI element. No highlighting is applied to UI elements that have not been identified by the set of rules.

The computer 101 may also provide information about the identified UI elements on the displayed page. For instance, a label and other text describing each identified UI element may be displayed alongside that UI element's bounding box.

When the computer 101 displays the page, it may also provide tools that enable a user to make a quality assessment. The tools enable one or more users to review the displayed page to ensure that all of the UI elements are identified and described correctly.

At block 235, one or more users generate feedback about any unidentified UI elements and incorrect text. If a UI element is not highlighted, the tools enable a user to mark an unidentified element. If text is incorrect (e.g., a UI element is mislabeled), the tools enable the text to be corrected.

In some instances, feedback could be generated by another computer, such as end user device 103. A screenshot is sent to the end user device 103, and the end user device 103 sends user feedback to the computer 101.

At block 240, the computer 101 receives user feedback. As used herein, the term “receives user feedback” includes the computer 101 receiving feedback from one or more users. The term also includes receiving feedback from external sources, such as end user device 103.

The feedback can be used to update the set of heuristic rules. If a UI element is not identified, the heuristic rules can be updated so it will identify that UI element. The following paragraphs describe a no-code approach towards updating the set of heuristic rules.

The no-code approach involves the use of a pipeline to a Large Language Model (LLM). An LLM learns statistical relationships from vast amounts of text during a computationally intensive self-supervised and semi-supervised training. An LLM can be used for text generation by taking an input text and repeatedly predicting the next token or word.

As used herein, a pipeline of an LLM refers to a series of steps or processes that use an LLM to accomplish a task or set of tasks. This pipeline often involves multiple stages, such as data preprocessing, model inference, and post-processing. For instance, in a text summarization pipeline, the steps might include cleaning and tokenizing the input text, feeding it into the LLM to generate a summary, and then refining the output to ensure coherence and readability.

At block 245, the computer 101 uses a first pipeline of an LLM to create a new rule for each UI element that is not visually highlighted. That is, the LLM creates a new rule for identifying a UI element that was not identified at block 225. The LLM may be accessible via the public cloud 105 or the private cloud 106.

The user feedback may also include information that enables the computer 101 to find an unidentified UI element in a page. For instance, the feedback may describe the function of the UI element, its style, it's context (e.g., position within a list, nearby UI elements), etc. Once the UI element is found, its attributes can be added to the first pipeline. Examples are provided below.

At block 250, each new rule is tested see whether it identifies the previously unidentified UI element. If a new rule does not accurately identify the previously unidentified UI element, control is returned to block 235, and that new rule is iteratively tested and adjusted until its corresponding UI element is accurately identified. If a new rule identifies UI elements that were also identified by other rules in the set of heuristic rules, a conflict occurs, and the new rule is iteratively tested and adjusted until the conflict is avoided. If a new rule is tested as part of UI automation, and the new rule does not work correctly, the new rule is iteratively tested and adjusted until it does work correctly.

At block 255, the computer 101 may use a second pipeline of the LLM to suggest new names for each UI element identified by a new rule. Attributes and context of a newly identified UI element may be provided on the second pipeline along with another set of rules regarding the naming. The naming will be described in detail below.

At block 260, once the coverage and accuracy of the given application page are acceptable, the computer 101 updates the set of heuristic rules with any new rules. The updated set of heuristic rules may be stored so it can be leveraged for other applications and other users.

The method of FIG. 2 offers several advantages over relying solely on LLMs to identify UI elements in a page of an application. The heuristic rules are deterministic. Unlike LLMs, there is no randomness involved in identifying the UI elements. The heuristic rules will always produce the same output from a given starting condition or initial state. They ensure consistent, reliable, and predictable behavior in automated tasks, reducing the risk of errors and inconsistencies that can arise from the more flexible but less deterministic nature of language models.

Because the rules are heuristic, they are more flexible, can cover wide range of UI elements. Heuristic rules are also adaptable to new UI elements.

Even though an LLM is used to generate new rules, the iterative testing and updating of the new rules overcomes the problem with the probabilistic nature of the LLM. Even if the LLM might sometimes “hallucinate,” the iterative process and user feedback can identify any hallucinations.

The no-code approach towards updating the set of heuristic rules has its own advantages. A user doesn't have to know how to navigate a page or DOM. Further, the user doesn't have to know the syntax of the rules file. The method enables non-technical business users to generate precise and safe heuristic rules for UI automation.

### Another Example Method of Identifying UI Elements and Updating Rules

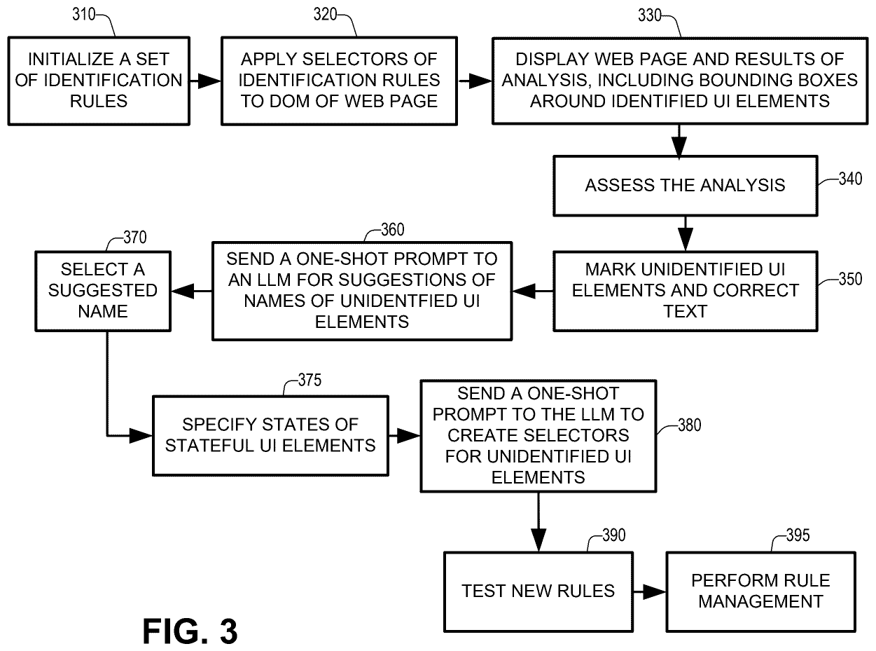

Reference is now made to FIG. 3 which illustrates a specific example of a computer-implemented method for identifying and naming UI elements in a page of a web browser. At block 310, a set of heuristic rules are initialized by loading a file that contain the set of heuristic rules. The file may follow a YAML format, which is commonly used format for configuration files where data is being stored or transmitted. The file may contain a list of objects, where each object represents a heuristic rule.

Each rule may have a type. Examples of types include a “regular” rule, a “group” rule, a “context” rule, and a “miscellaneous” rule. A regular rule may cover UI elements such as buttons and inputs. A group rule may cover group UI elements such as forms. A context rule may cover detection context. A miscellaneous rule may include custom rules, extensions to regular and group rules, etc.

Each rule has a selector. For example, the selector may be a Cascading Style Sheets (CSS) selector. CSS is a style sheet language that enables presentation and content to be separated. A CSS selector declares which part of the markup a style applies to by matching tags and attributes in the markup itself. For the purposes herein, the CSS selector declares which UI elements a rule applies by matching tags and attributes in the page itself.

Each rule has a highlighting feature. For example, the highlighting feature could be a certain color indication for the user to see on the screen.

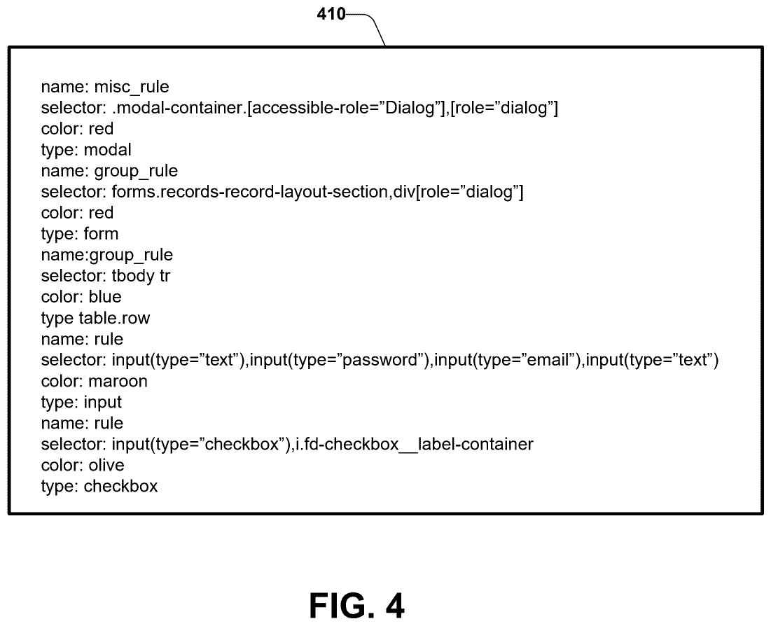

Additional reference is made to FIG. 4, which provides an example of the structure of a rules file 410. Four rules are illustrated, with each rule defined by a name, selector, color, and type. The first rule, a miscellaneous rule, defines the focus area (dialog) in the HTML. The second rule, a group rule, defines the hierarchy (form) of the elements. The third rule, a regular rule, selects a text field by its type according to its CSS selector. The fourth rule, also a regular rule, selects a checkbox by its type according to its CSS selector.

Returning to FIG. 3, at block 320, the page is analyzed by applying the selectors of the rules to a DOM of the web page. A context rule that identifies modals may be applied to identify any modals. Different regular rules may identify different UI elements. Other context rules may be applied to determine different contexts for each identified UI element. Group rules may be applied to determine whether any of the identified UI elements are part of a group. For example, a group element might identify sub-children in a nested topology.

A miscellaneous rule may be applied to determine whether any of the identified UI elements are stateful. For example, a button may have two states: on and off. An attachment may have two states: loaded and unloaded. The miscellaneous rule may determine the state, or user feedback may indicate the state.

At block 330, the web page and results of the analysis are displayed. The results include a bounding box having the rule-specified color drawn around each identified UI element. Accompanying each bounding box may be a unique identifier and nested textual output representing an understanding of the bounded UI element.

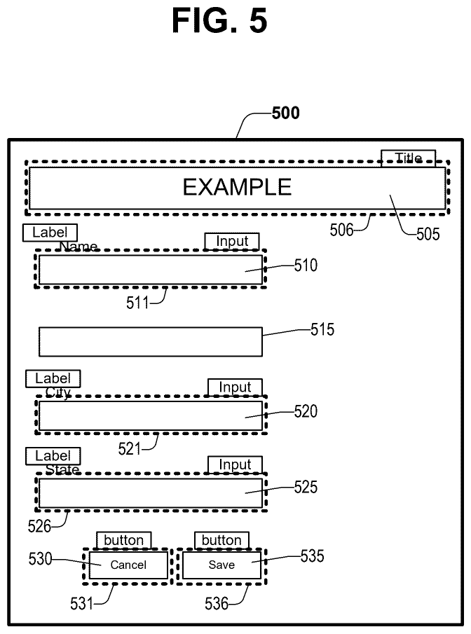

Additional reference is made to FIG. 5, which provides an example of a screen 500 that displays analysis results. The screen 500 displays a title bar 505, first, second, third and fourth input fields 510, 515, 520 and 525, and buttons 530 and 535. The analysis results identify the title bar 505, four input fields 510, 520 and 525, and the buttons 530 and 535. Bounding boxes 506, 511, 521, 526, 531 and 536 are drawn around those UI elements 505, 510, 520, 525, 530 and 535, respectively. Text (“Title,” “Input” and “Button”) indicating the types of those UI elements are added. Labels (“Name,” “City” and “State”) associated with the first, third and fourth input fields 510, 520 and 525 are also identified and text (“Label”) is added.

The second input field 515 is not identified by the analysis. A bounding box is not drawn around the second input field 515.

Returning to FIG. 3, at block 340, an assessment of the analysis is performed. By viewing the display, a user can assess the quality of the analysis and identify coverage, missing names, duplicates and conflicting rules issues. For instance, the user can assess whether the bounding boxes, their colors and their tags are correct. The user can also to select a particular UI element, highlight it, and view its detailed metadata.

At block 350, unidentified UI elements are marked and incorrect text is corrected. A user selects an unidentified UI element. For example, the user can click on a selector tool. The user moves a mouse cursor over the UI element, and a new bounding box is drawn over the unidentified UI element.

The UI elements within the new bounding boxes are named. In some embodiments, the display may enable the users to determine and enter the names of the unidentified UI elements. In the example of FIG. 3, however, the second pipeline of the LLM is used to provide the names.

At block 360, a prompt is sent to the LLM. A one-shot prompt may include instructions, followed by a one-shot input. The input may have the following canonical form:
[style/state modifier] [element name] [element type] [anchoring reference].
   The anchoring reference may include one or more of the following: relative position (e.g., next to a search field); context-driven reference (e.g., other UI elements in the same row); positional (e.g., second item in a list); nesting/hierarchical (e.g. within a form); inner text (e.g., “Submit”).

At block 370, the LLM responds to the prompt by discovering one or more semantic meanings of the UI element. These meanings are treated as suggestions. In some instances, only a single suggestion is displayed, and the user may validate the single suggestion or input a different name. In other instances, a plurality of different suggestions displayed, for example, in the form of a prioritized list. The user may select the best suggestion or input a different name.

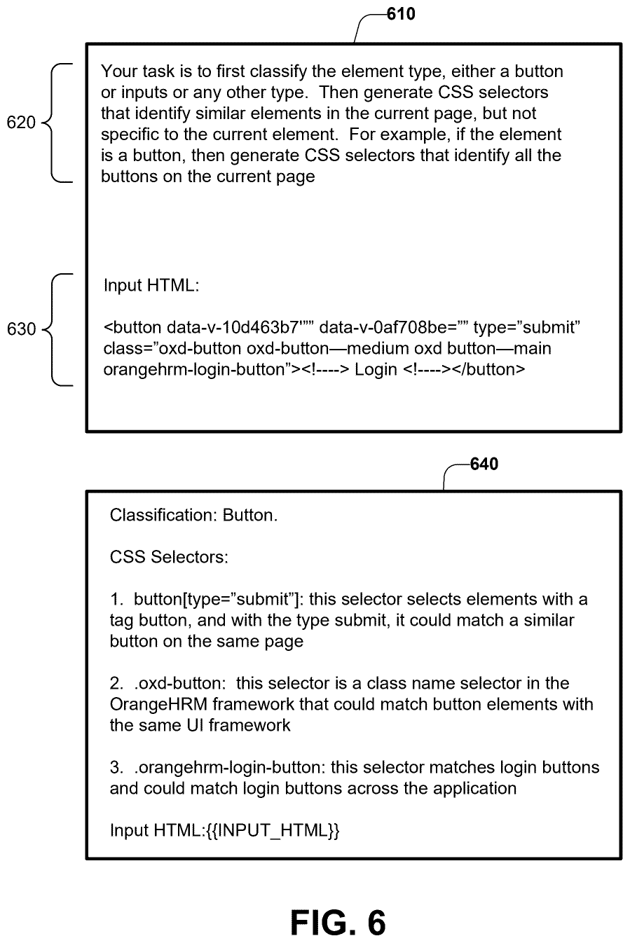

Additional reference is made to FIG. 6, which illustrates a simple example of a prompt 610 for suggesting the names for a blue login button. The prompt 610 includes instructions 620 and a one-shot input 630 to suggests names for a blue login button. The LLM provides an output 640 that provides three suggestions. All three suggestions include the name (“button”) of the UI element. The first suggestion modifies the name with the style (“blue”). The second suggestion modifies the name with inner text (“login”). The third suggestion modifies the name with both the style and the inner text.

At block 375, states of stateful UI elements may be specified. For example, the UI element “attachment” might have a loaded state or an unloaded state. The display may allow the user to specify the state of the attachment.

At block 380, the computer 101 uses the first pipeline to create a CSS selector for each UI element within a new bounding box. When a new bounding box is created, the attributes of the UI element within are accessed and used to form a prompt. A one-shot prompt may include instructions specifying the creation of a CSS selector, followed by a one-shot input containing attributes or code defining the UI element.

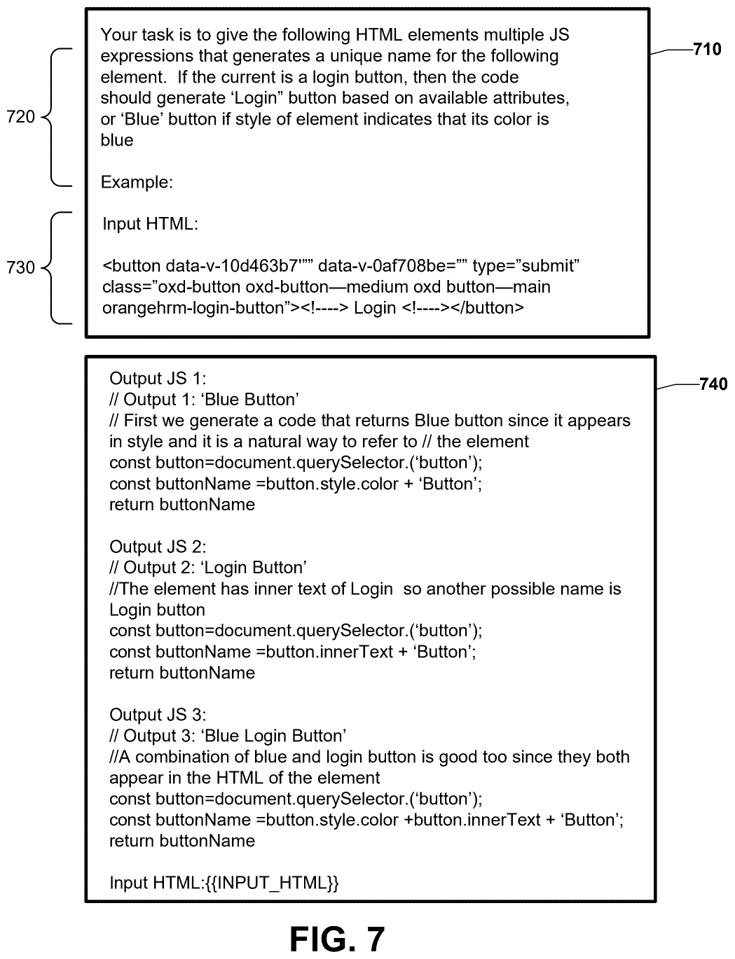

Additional reference is made to FIG. 7, which illustrates an example of a prompt 710 for creation of a CSS selector for a “submit” button. The prompt 710 includes instructions 720 specifying the creation of a CSS selector and a one-shot input 730 containing the HTML language defining the UI element.

The LLM responds to the prompt by providing one-shot output 740. The one-shot output specifies a new rule containing three CSS selectors.

At block 390, each new rule is tested and validated. The testing may include determining whether the new rule conflicts with any existing rules. A conflict occurs if the new rules catch any UI elements that were identified by the existing rules. In the case of a conflict, the second pipeline can update the new rule to make it more specific. Control is returned to block 340, and the updated rule is then tested once again.

The testing may further include using the results of the classification in UI automation, and ensuring that desired results are achieved. If desired results are not achieved, control is returned to block 340.

At block 395, rule management is performed. Once a new rule has been validated, the validated rule is saved. The user may decide whether the validated rule is stored in a global rule file or a local rule file.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

It should be appreciated that the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method comprising:
applying a set of heuristic rules to a page of an application to identify a plurality of (UI) elements in the page;
displaying the page, including visually highlighting each UI element of the plurality that is identified by the set of rules;
receiving user feedback that identifies each UI element of the plurality that is not visually highlighted; and
using a first pipeline of a Large Language Learning model (LLM) to create a new rule identifying each UI element that is not visually highlighted.

2. The method of claim 1, wherein the set of heuristic rules comprises:
a first subset for identifying individual UI elements;
a second subset for detecting UI element groups; and
a third subset for detecting UI element context.

3. The method of claim 1, wherein the highlighting comprises:
creating a bounding box around each UI element that is identified by the set of rules; and
displaying text describing each UI element within a bounding box.

4. The method of claim 1, further comprising iteratively testing and adjusting each new rule until its corresponding UI element is accurately identified.

5. The method of claim 4, wherein for a given new rule:
using the first pipeline comprises creating a prompt for the given new rule, and sending the prompt to the LLM; and
the iteratively testing and adjusting includes adjusting the prompt with the user feedback until the given new rule accurately identifies its corresponding UI element.

6. The method of claim 5, wherein the prompt for the given new rule includes instructions for creating a selector, and attributes of the corresponding UI element.

7. The method of claim 1, further comprising:
using a second pipeline of the LLM to suggest names for a given UI element that is not visually highlighted; and
obtaining further user feedback to make a selection among the names.

8. The method of claim 7, wherein:
using the second pipeline comprises creating a prompt for the given UI element, and sending the prompt to the LLM;
the prompt comprises instructions for selecting a plurality of names, and a one-shot input; and
the one-shot input has a form
[style/state modifier] [name] [type] [anchoring reference]
where the style, state, name and type are attributes of the given UI element, and the anchoring reference describes context of the given UI element.

9. The method of claim 1, further comprising:
identifying states of stateful UI elements;
displaying the identified states; and
obtaining additional user feedback to update any displayed states.

10. The method of claim 1, further comprising updating the set with a new rule created by the LLM.

11. A computer system comprising a memory having computer readable instructions; and one or more processors for executing the computer readable instructions to configure the computer system to:
run an application to display a page including a user interface (UI);
apply a set of heuristic rules to the page to identify a plurality of UI elements;
display the page including the plurality of UI elements;
visually highlight each UI element of the plurality that is identified by the set of rules;
receive user feedback that identifies each UI element of the plurality that is not visually highlighted; and
use a first pipeline of a Large Language Learning model (LLM) to create a new rule identifying each UI element that is not visually highlighted.

12. The computer system of claim 11, wherein the computer readable instructions, when executed, further configure the one or more processors to iteratively test and adjust each new rule until its corresponding UI element is accurately identified.

13. The computer system of claim 12, wherein for a given new rule:
a prompt for the given new rule is created and sent to the LLM; and
the prompt is iteratively adjusted with the user feedback until the given new rule accurately identifies its corresponding UI element.

14. The computer system of claim 13, wherein the prompt for the given new rule includes instructions for creating a selector, and attributes of the corresponding UI element.

15. The computer system of claim 11, wherein the computer readable instructions, when executed, further configure the one or more processors to use a second pipeline of the LLM to suggest names for a given UI element that is not visually highlighted.

16. A computer program product comprising one or more computer-readable memory devices encoded with data including computer-readable instructions that, when executed, causes a processor set to carry out a method of identifying user interface (UI) elements in a page of an application, the method comprising:
applying a set of heuristic rules to the page to identify the UI elements;
displaying the page;
visually highlighting each of the UI elements that is identified by the set of rules;
receiving user feedback that identifies each of the UI elements that is not visually highlighted; and
using a first pipeline of a Large Language Learning model (LLM) to create a new rule identifying each UI element that is not visually highlighted.

17. The computer program product of claim 16, wherein the computer readable instructions, when executed, further configure the processor set to iteratively test and adjust each new rule until its corresponding UI element is accurately identified.

18. The computer program product of claim 17, wherein:
a prompt for a given new rule is created and sent to the LLM; and
the prompt is iteratively adjusted with the user feedback until the given new rule accurately identifies its corresponding UI element.

19. The computer program product of claim 18, wherein the prompt for the given new rule includes instructions for creating a selector, and attributes of the corresponding UI element.

20. The computer program product of claim 16, wherein the computer readable instructions, when executed, further configure the processor set to use a second pipeline of the LLM to suggest names for each UI element that is not visually highlighted.
